(19) United States
(12) Patent Application Publication
(10) Pub. No.: US 2018/0192329 A1
(43) Pub. Date: Jul. 5, 2018

(54) Dynamic Bandwidth Selection

(71) Applicant: Cypress Semiconductor Corporation, San Jose, CA (US)

(72) Inventors: Kamesh Medapalli, San Jose, CA (US); Sungeun Lee, Brunswick, NJ (US); Saishankar Nandagopalan, San Diego, CA (US); Sridhar Prakasam, Morganville, NJ (US)

(73) Assignee: Cypress Semiconductor Corporation, San Jose, CA (US)

(21) Appl. No.: 15/637,270

(22) Filed: Jun. 29, 2017

Related U.S. Application Data
(60) Provisional application No. 62/442,253, filed on Jan. 4, 2017.
(60) Provisional application No. 62/474,230, filed on Mar. 21, 2017.

(51) Int. Cl. H04W 28/20; H04J 3/16; H04W 72/04; H04L 1/00; H04W 84/18; H04L 1/20; H04W 74/08

(52) U.S. Cl. CPC H04W 28/20; H04J 3/1682; H04W 72/0446; H04W 74/0833; H04W 84/18; H04L 1/203; H04L 1/0023

(57) ABSTRACT

Dynamic bandwidth selection based on environmental conditions is described. A bandwidth of a sub-bandwidth may be selected based on signal strength, channel interference, or overlap to optimize throughput and/or energy per bit. Additionally, system power level may define a communication bandwidth.

### RELATED APPLICATIONS

This patent application claims the benefit of U.S. Provisional Patent Application No. 62/442,253, filed Jan. 4, 2017 and U.S. Provisional Patent Application No. 62/474,230, filed Mar. 21, 2017, which are incorporated by reference herein in their entirety.

### TECHNICAL FIELD

The present disclosure relates generally to wireless systems, and more particularly connectivity of wireless devices at certain bandwidths.

### BACKGROUND

As wireless connectivity becomes more ubiquitous, the available bandwidths and frequencies for communication are quickly saturating. At the same time, users demand more from their wireless devices in terms of the amount of data to be communicated as well as the range and reliability of the communication. And as users are more frequency taking their wireless devices with them, battery life and power management are becoming more important. Each of these demands necessarily places stress on various performance characteristics.

Optimizing data throughput, power consumption, and broadcast power may allow wireless devices to meet the needs and requirements user application in a growing and more crowded wireless space.

### DESCRIPTION OF THE DRAWINGS

FIG. 1 illustrates a terminal system with dynamic bandwidth selection, according to one embodiment.

FIG. 2 illustrates a terminal system with dynamic bandwidth selection, according to one embodiment.

FIG. 3 illustrates a graphical representation of throughput vs. attenuation for various communication bandwidths, according to one embodiment.

FIG. 4A illustrates a graphical representation of throughput vs. attenuation for various communication bandwidths, according to one embodiment.

FIG. 4B illustrates a graphical representation of energy per bit vs. attenuation for various communication bandwidths, according to one embodiment.

FIG. 4C illustrates a graphical representation of energy per bit vs. attenuation for various communication bandwidths, according to one embodiment.

FIG. 5A illustrates steps for changing bandwidth, according to one embodiment.

FIG. 5B illustrates steps for changing bandwidth, according to one embodiment.

FIG. 5C illustrates steps for changing bandwidth, according to one embodiment.

FIG. 6 illustrates bandwidths and sub-bandwidths, according to one embodiment.

FIG. 7 illustrates a method for entering various dynamic bandwidth selection schemes according to frequency and available bandwidths, according to one embodiment.

FIG. 8 illustrates a method for selecting appropriate bandwidths (bands) or sub-bandwidths (sub-bands), according to one embodiment.

FIG. 9 illustrates a method for communication of bandwidth information between an access point and a terminal, according to one embodiment.

### SUMMARY

A wireless communication device and method are described wherein a radio frequency (RF) front end may be configured to communicate in one of several bandwidths or sub-bandwidths based on analysis of system and environmental characteristics, such as a received signal strength indicator (RSSI), adjacent channel interference (ACI), overlapping basic service set (OBSS), power level, or other characteristics. Bandwidths and sub-bandwidths may be given a score or credit and a bandwidth may be selected based on the scores assigned to the bandwidths and sub-bandwidths.

### DETAILED DESCRIPTION

When signal quality is good, that is when the signal strength is high and interference is low, communication at wider bandwidths may provide greater throughput compared to communication at narrower bandwidths. Communication at narrower bandwidths may provide a wider range for efficient data transmission as more bands of narrow bandwidth may yield communication at lower interference levels. Similarly, energy-per-bit efficiency may be improved at narrower bandwidths when signal quality is low due to low signal strength or high interference. In the following specification bandwidth may be referred to as band as specific bandwidths are referenced. Similarly, sub-bands or sub-bandwidths may refer to subsets of bandwidths in a band or bandwidth.

IoT-enabled devices may be incorporated into systems that must operate in varied conditions with wide ranges of signal strength, interference and power levels. A bandwidth selection circuit capable of adapting to varied conditions dynamically can optimize performance based on the conditions in light of application requirements. Similarly, a bandwidth selection circuit may allow an IoT device to communicate to access points (APs) that prefer or require certain bandwidths, or bands or sub-bands, are preferred and request a change to optimize communication performance. Optimization may be for range, operational life, or data integrity, in various embodiments.

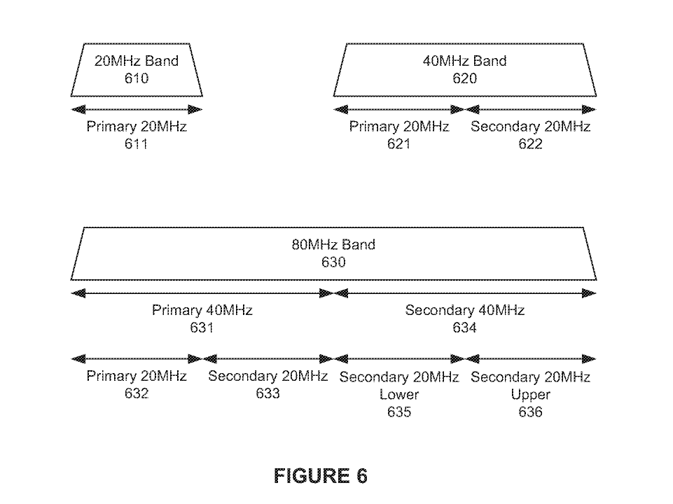

FIG. 6 illustrates different sub-bands within available band for different communication frequencies. For purposes of explanation, 20 MHz, 40 MHz, and 80 MHz bands and sub-bands are shown, but one of ordinary skill in the art would understand that other band and sub-band may be used depending on the communication frequencies and system parameters. If only a single 20 MHz band is available for a given communication frequency, communication may occur solely within that band. In one embodiment, devices that communicate at a frequency of 2.4 GHz may use either 20 MHz band 610 with primary 20 MHz band 611 or 40 MHz band 620 with primary 20 MHz sub-band 621 and secondary 20 MHz sub-band 622. In another embodiment, devices that communicate at a frequency of 5 GHz, such as defined by 802.11ac, may have an additional 80 MHz band 630 with a primary 40 MHz sub-band 631 and a secondary 40 MHz sub-band 634. Primary 40 MHz sub-band 631 may be further refined into primary 20 MHz sub-band 632 and secondary 20 MHz sub-band 633. Secondary 40 MHz sub-band 634 may be further refined into secondary 20 MHz lower sub-band 635 and secondary 20 MHz upper sub-band 636.

If bands are enabled by a specific communication frequency that can be separated into sub-bands, such as 40 MHz band 620 or 80 Mhz band 630 it may be possible or even preferred to select a specific sub-band or the entire band based on the environmental or system requirements. A circuit or method is therefore required to analyze and understand environmental conditions, impacts on data throughput and energy-per-bit impacts, and system requirements, and to request or require communication within the best available band or sub-band.

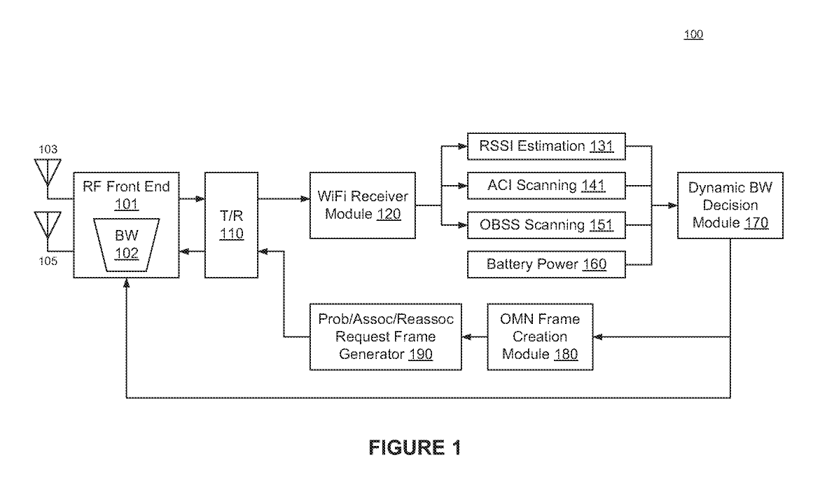

FIG. 1 illustrates a wireless station terminal (STA) 100 configured in an infrastructure mode. STA 100 may be wirelessly coupled to an access point (AP, not shown) or multiple APs. STA 100 may be configured for initial association or re-association with an AP. That is, STA 100 may be configured to define or request a band for communication with an AP or APs based on system requirements and the applicable wireless communication standard. The AP or APs may manage association with and connection to WiFi devices when in infrastructure mode. STA 100 may include a RF front end 101. RF front end 101 may include band circuit 102 for setting the RF band in which STA 100 communicates to the AP or APs. The RF band may be selected according to FIG. 6 and RF front end 101 may be configured accordingly as described below. RF front end 101 may be coupled to an antenna 103 or multiple antennae 103 and 105 for wireless communication of information from STA 100 to AP or APs.

RF front end 101 may be coupled to a transmit/receive (T/R) module 110. T/R module 110 may configure information to be transmitted from RF front end 101 or may process information received at RF front end 101 for downstream devices or processing circuitry. Information received by T/R module 110 may be passed to WiFi receiver module 120 and, from there, distributed to downstream processing and analytics modules. Downstream processing analytic modules may include a received signal strength indicator (RSSI) estimation module 131 for estimation of the quality of the wireless link between the STA and the AP. Downstream processing analytic modules may also include an adjacent channel interference (ACI) scanning module 141 to scan and quantify interference on the channel under test from adjacent channels. A channel may correspond to a specific band or sub-band according to FIG. 6. Downstream processing analytic modules may also include an overlapping basic service set (OBSS) scanning module to determine if there are other basic service sets (BSSs) that may share STAs, APs, or channels (bands). OBSS may also be referred to as BSS collision. STA 100 may scan RSSI, ACI and OBSS for multiple APs and for multiple band options depending on the available bands or sub-bands of bandwidth (BW) configuration circuit 102.

Outputs of RSSI estimation module 131, ACI scanning module 141, and OBSS scanning module 151 may be sent to a dynamic BW decision module 170, which along with battery power information from battery power module 160, may determine a band or sub-band for communication of wireless data between the STA 100 and the AP or APs. Dynamic BW decision module 170 may configure the bandwidth circuit 102 for the desired band or sub-band from the available band and sub-band options. Dynamic BW decision module 170 may also pass the band decision to an operating mode notification (OMN) frame creation module 180 to create a notification for the AP or APs that the STA will be operating in the specified band or sub-band. OMN frame creation module 180 may provide the OMN frame to probe request, association request, re-association (“prob/assoc/reassoc”) request frame generator 190, which provides the request to T/R module 110 for transmission from the STA 100 to the AP or APs through RF front end 101.

In one embodiment, dynamic BW decision module 170 may select a narrower band if any one of a number of conditions are detected by RSSI estimation module 131, ACI scanning module 141, OBSS scanning module, or battery power module 160. For example, if RSSI estimation module 131 determines a low RSSI, the ACI from ACI scanning module 141 is too high, or the battery level is too low, a lower bandwidth may provide optimal energy efficiency and/or throughput efficiency. In various embodiments, certain parameters from the downstream processing analytic modules may be given different weights. In applications where ACI is of particular concern, higher weight may be provided to the output of ACI scanning module 141. In such an embodiment, even small amounts of interference from adjacent channels may be dispositive and a narrower band or sub-band or a different peer band or sub-band may be selected. In other embodiments, battery power may be the most important factor. If battery power module 160 indicates a low power level, narrower bands or sub-bands may be selected regardless of the ACI, RSSI, or other analytical indicia.

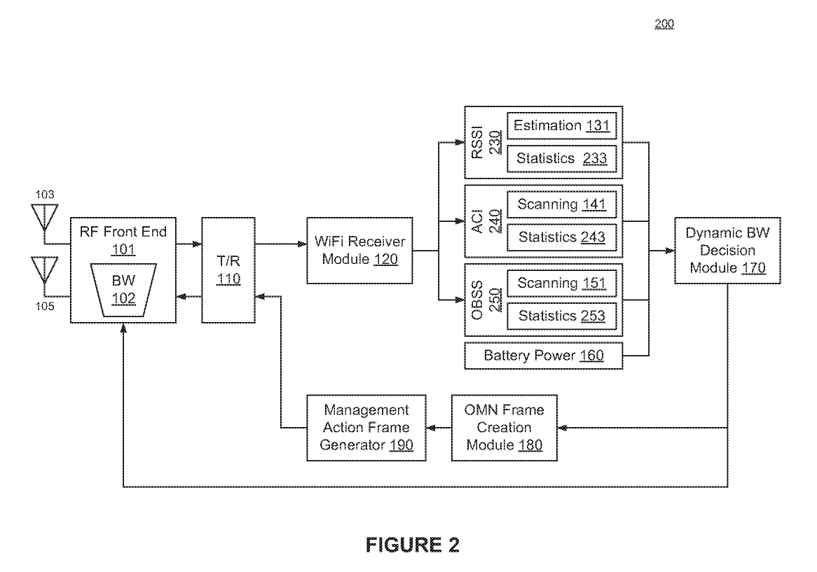

FIG. 2 illustrates an STA 200 configured in an infrastructure mode and operable for dynamic BW selection during run-time. STA 200 may include RSSI statistics module 233 with RSSI estimation module 131 as part of an RSSI block 230. STA 200 may also include ACI statistics module 243 with ACI scanning module 141 as part of an ACI block 240. STA 200 may also include OBSS statistics module 253 with OBSS scanning module 151 as part of an OBSS block 250. STA 200 may also include battery monitor 260 for monitory battery power level.

STA 200 may collect statistics on RSSI, ACI, and OBSS from RSSI block 230, ACI block 240, and OBSS block 250, respectively. But STA may also monitor instantaneous RSSI, ACI, and OBSS from the RSSI estimation module 131, ACI scanning module 141, and OBSS scanning module 151. Based on the statistics of the signal and interference, as well as the medium scan result and battery level, dynamic BW decision module 170 may decide the optimal band or sub-band and trigger a band switching algorithm by sending an OMN frame or a request-to-send (RTS)/clear-to-send (CTS) request to the AP.

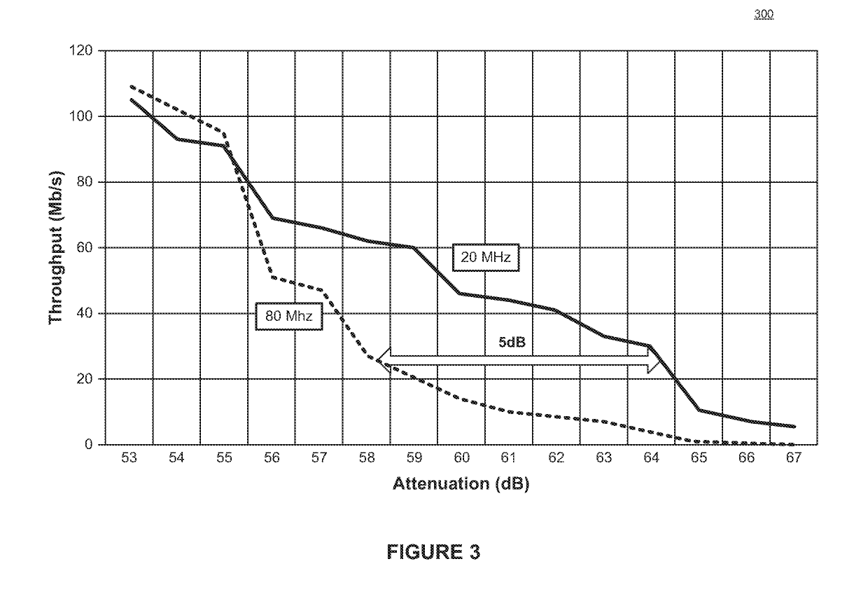

FIG. 3 illustrates attenuation 300 of a signal at two operating bandwidths, 20 MHz and 80 MHz. At greater attenuations levels (for example, at greater distances or with greater interference) throughput may be higher for narrower-band communication. For example, at approximately 25 Mb/s, 20 MHz communication may have approximately 5 dB greater robustness on attenuation. Similarly, at approximately 58 dB attenuation, there may be approximately 37 Mb/s more throughput for narrower-band communication (20 MHz). This illustrates that narrower bands may be better for communication at greater distances, through difficult media, or in noisier environments.

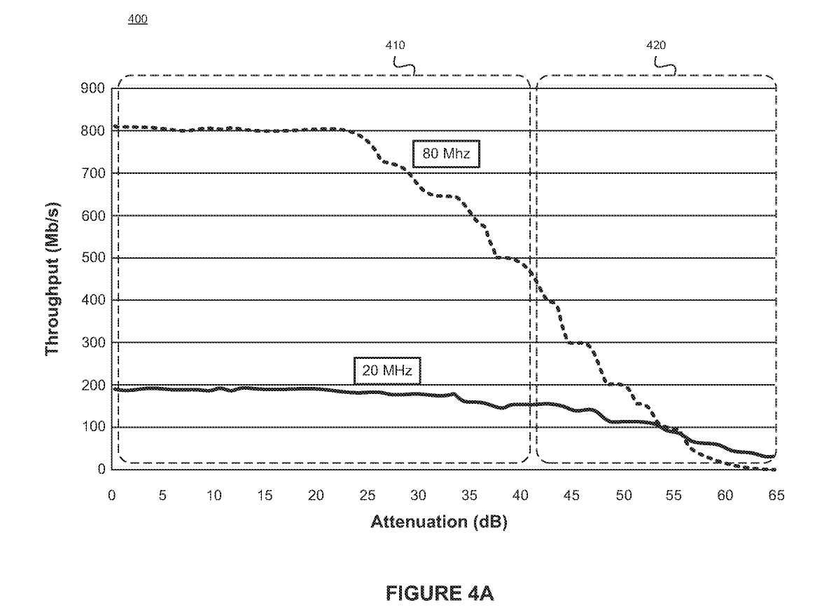

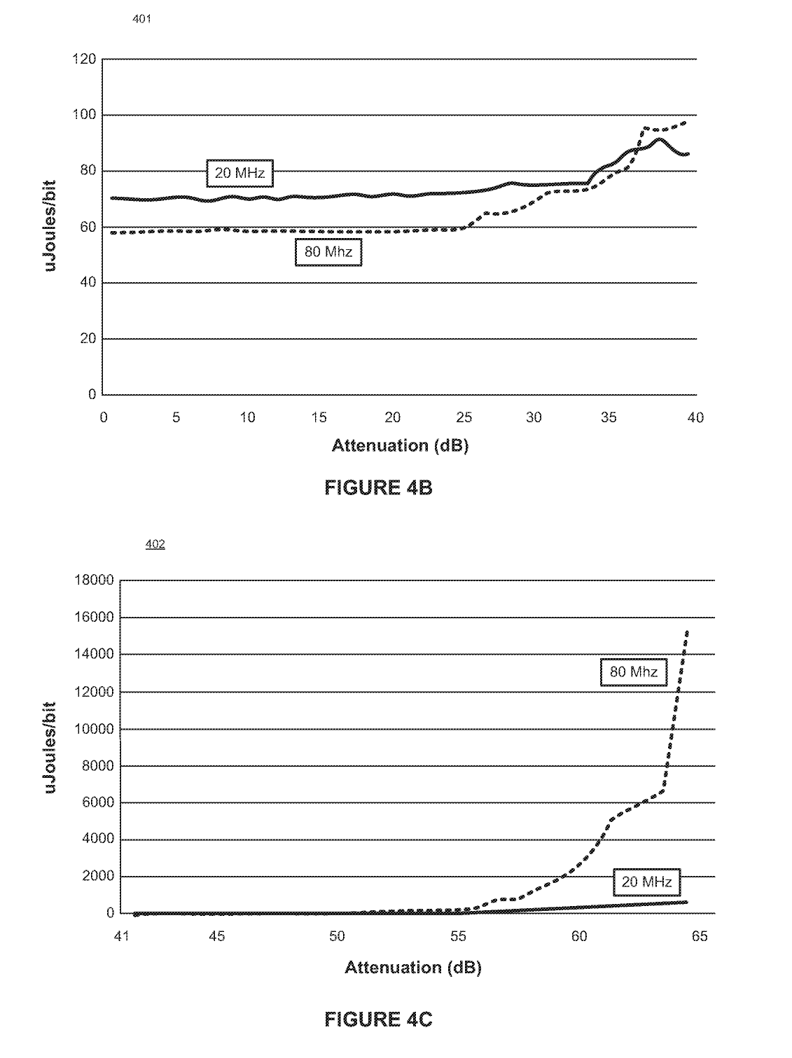

FIG. 4A illustrates a graph 400 of attenuation vs. throughput for a wider range of attenuation levels than FIG. 3. At lower attenuation levels, wider bandwidths may have greater throughput. The energy required for communication of information may therefore be less. FIG. 4B illustrates a graph 401 the energy required in a first region 410 of FIG. 4A. At lower attenuation levels, wider-bandwidth communication may require slightly less energy per bit. However, FIG. 4C illustrates a graph 402 that at higher attenuation levels, wider-bandwidth communication may require significantly higher levels of energy per bit for region 420 of FIG. 4A. Consequently, at higher attenuation levels, it may be better to choose narrower bands; instead of maintaining communication in an 80 MHz band, it may be desired to move to a narrower band, such as 40 MHz or 20 MHz, to reduce the amount of energy per bit.

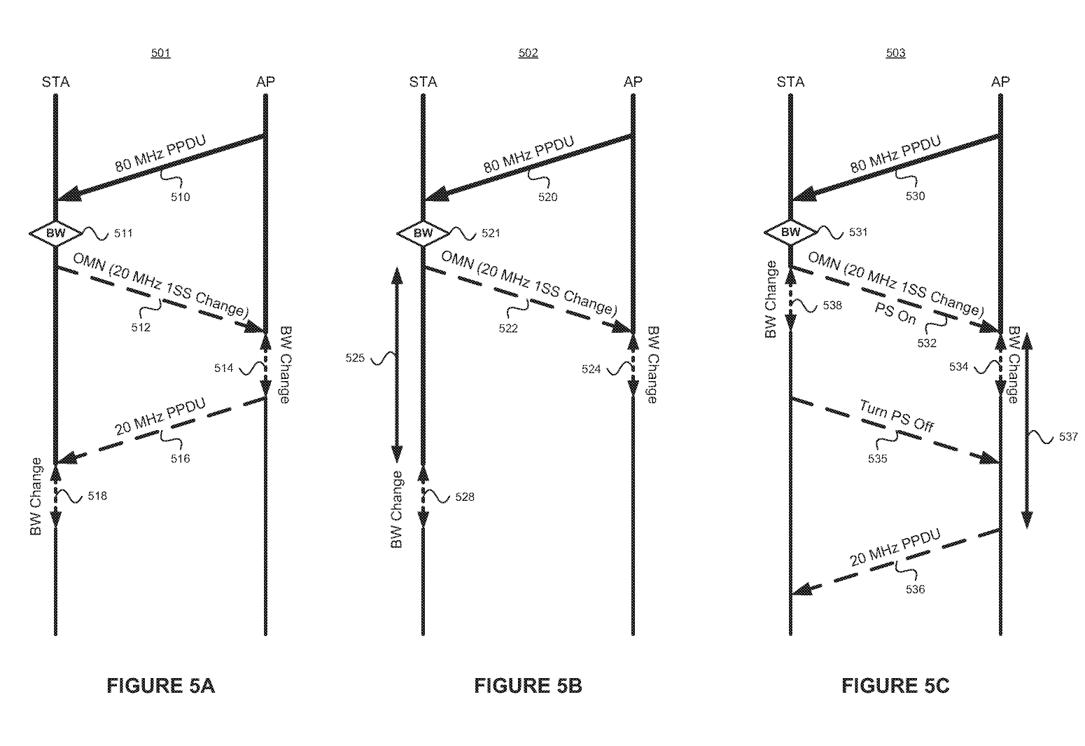

FIG. 5A illustrates one embodiment 501 of steps for changing operating bandwidth from 80 MHz to 20 MHz by using an OMN frame and an physical layer protocol data unit (PPDU) channel width change. First, the information PPDU with 80 MHz channel width is delivered from AP to STA in step 510. After the STA determines to shrink its operating bandwidth to 20 MHz in step 511, it transmits an OMN frame to the AP for requesting the bandwidth change in step 512. Once AP receives the OMN frame and changes the operating bandwidth to the desired bandwidth (20 MHz) that was sent in the OMN frame in step 514, AP sends the information to the STA in a 20 MHz PPDU format in step 516. After STA receives the information from AP in the 20 MHz PPDU format, STA finally may change its reception operating bandwidth to 20 MHz in step 518.

FIG. 5B illustrates an embodiment 502 for changing operating bandwidth from 80 MHz to 20 MHz using on an OMN frame. Without getting the 20 MHz PPDU format signal from AP which actually confirms the bandwidth change, the STA changes its own reception operating bandwidth to 20 MHz after a timeout. The timeout period may be configured to meet application-specific needs. The information PPDU with a 80 MHz channel width is delivered from AP to STA in step 520. After the STA determines to shrink its operating bandwidth to 20 MHz in step 521, it transmits an OMN frame to the AP for requesting the bandwidth change in step 522. The AP may then receive the OMN frame and change the operating bandwidth to the desired bandwidth (20 MHz) that was sent in the OMN frame in step 524. The STA may then change its reception operating bandwidth to 20 MHz in step 518 after a timeout period 525.

FIG. 5C illustrates an embodiment 503 for changing an operating bandwidth from 80 MHz to 20 MHz by using power saving modes. First, the information PPDU with 80 MHz channel width is delivered from AP to STA in step 530. After the STA determines to shrink its operating bandwidth to 20 MHz in step 531, it transmits an OMN frame an indication that power saving (PS) mode is on in step 532. The STA may then change its reception operating bandwidth to 20 MHz in step 538 because PS mode is on. The AP may then receive the OMN frame and PS mode from the STA and change its operating bandwidth to the desired bandwidth (20 MHz) that was sent in the OMN frame in step 534. Once the STA has changed its operating bandwidth, it may send PS mode off information to the AP in step 535. After a timeout 537, the AP may send information to the STA in a 20 MHz PPDU format in step 516.

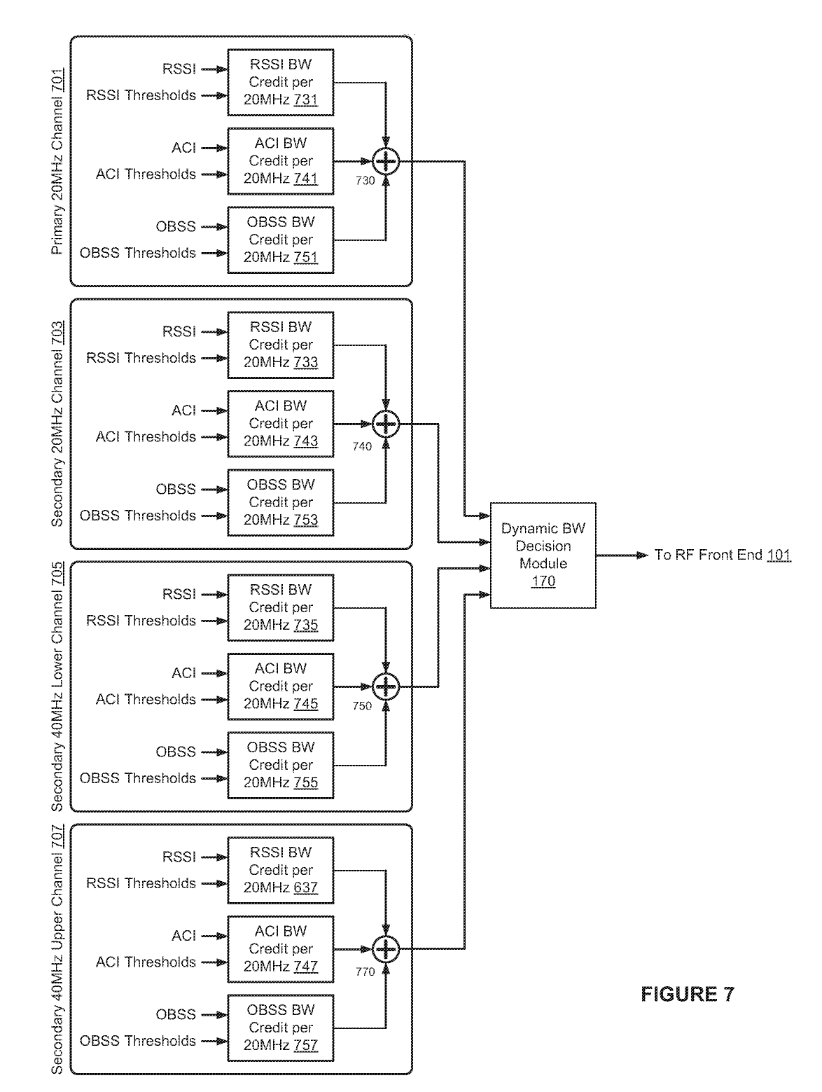

FIG. 7 illustrates a system 700 for analyzing and quantifying the quality of multiple bands or sub-bands (often referred to as channels and sub-channels), the output of each analysis may be provided to dynamic BW decision module 170. In the example shown in FIG. 7, an 80 MHz band may be used, constituting several sub-bands as explained in FIG. 6. For the 80 MHz band and each of its constituent sub-bands, various metrics may be gathered by the RSSI estimation, ACI scanning, and OBSS scanning modules, as illustrated in FIGS. 1 and 2. For each scanning module, an input and at least one threshold may be provided, which are used to determine a credit or value for each parameter.

For primary 20 MHz sub-band 701, an RSSI BW credit 731 may be given based on the measured RSSI and the at least one RSSI threshold. Similarly, an ACI BW credit 741 may be given based on the measured ACI and the at least one ACI threshold. An OBSS BW credit 751 may be given based on the measured OBSS and the at least one OBSS threshold. The credits may then be summed by summing module 730 to provide an overall credit, value, or score for primary 20 MHz sub-band 701. For secondary 20 MHz sub-band 703, an RSSI BW credit 733 may be given based on the measured RSSI and the at least one RSSI threshold. Similarly, an ACI BW credit 743 may be given based on the measured ACI and the at least one ACI threshold. An OBSS BW credit 753 may be given based on the measured OBSS and the at least one OBSS threshold. The credits may then be summed by summing module 740 to provide an overall credit, value, or score for secondary 20 MHz sub-band 703.

For secondary 40 MHz channel lower (sub-band) 705, an RSSI BW credit 735 may be given based on the measured RSSI and the at least one RSSI threshold. Similarly, an ACI BW credit 745 may be given based on the measured ACI and the at least one ACI threshold. An OBSS BW credit 755 may be given based on the measured OBSS and the at least one OBSS threshold. The credits may then be summed by summing module 750 to provide an overall credit, value, or score for secondary 40 MHz channel lower (sub-band) 705. For secondary 40 MHz channel upper (sub-band) 707, an RSSI BW credit 737 may be given based on the measured RSSI and the at least one RSSI threshold. Similarly, an ACI BW credit 747 may be given based on the measured ACI and the at least one ACI threshold. An OBSS BW credit 757 may be given based on the measured OBSS and the at least one OBSS threshold. The credits may then be summed by summing module 770 to provide an overall credit, value, or score for secondary 40 MHz channel lower (sub-band) 707.

In one embodiment, the bands and sub-bands of FIG. 7 may be merely illustrative and each band and sub-band of 80 MHz bandwidth may be evaluated separately. This analysis may be completed for each sub-band as well as for the 80 MHz band of which the sub-bands are constituent. The specifics of this analysis are not repeated in this description, but one of ordinary skill in the art would understand that sub-bands and the overall 80 MHz band may be analyzed in the same way.

As described above, the comparison of the various measured values of RSSI, ACI and OBSS, when compared to their respective thresholds may provide credits, values, or scores. For example, if the measured RSSI value is between an upper and a lower threshold, a credit or score of 2 may be given. If the ACI is low enough (below a threshold), a credit or score of 1 may be given. And if the measured OBSS is less than a threshold, a credit of 5 may be given. When all of the credits are added together, a band or sub-band may be given a score of 8. If that score is greater than scores (or credits or values) of other sub-band or of the wider band (40 MHz or 80 MHz), the sub-band with the highest score may be selected.

The procedure for primary 20 MHz sub-band 601 is repeated for the other sub-band (all of which are 20 MHz) as well as for the 40 MHz sub-bands and for 80 MHz. The band or sub-band with the highest score may be selected by dynamic BW decision module 170 and provided to RF front end 101 and the AP.

In another embodiment, a hierarchical approach may be used to select the appropriate band or sub-band. In one hierarchal approach, the selected band or sub-band may stretch out from primary 20 MHz sub-band 632. In this embodiment, each 20 MHz sub-band may be evaluated and decisions made on which 20 MHz, 40 Mhz, or 80 MHz band or sub-band based on scores of the constituent 20 MHz sub-bands.

If all four 20 MHz sub-bands have high scores (credits), the 80 MHz band 630 may be used for communication. If one of the 20 MHz sub-bands in secondary 40 MHz sub-band 634 has a low score (e.g. Secondary 20 MHz Lower 635), secondary 40 MHz sub-band 634 may not be used and communication may be limited to primary 40 MHz sub-band 631. This is illustrated in the examples in Table 1 below.

TABLE 1
Hierarchal Examples

| Example | | 1 | 2 | 3 | 4 | 5 | 6 | 7 | 8 |
|---|---|---|---|---|---|---|---|---|---|
| Selected BW | | 630 | 631 | 631 | 631 | 632 | 632 | 632 | 632 |
| Credits | 632 | 8 | 10 | 8 | 9 | 8 | 6 | 8 | 4 |
| (Scores) | 633 | 9 | 7 | 6 | 8 | 2 | 3 | 1 | 9 |
| | 635 | 8 | 1 | 10 | 2 | 9 | 10 | 4 | 4 |
| | 636 | 7 | 9 | 3 | 3 | 7 | 2 | 3 | 1 |

In Example 1, all of the 20 MHz sub-bands have high scores, so the full 80 MHz band 630 may be used. In Example 2, a low score on secondary 20 MHz sub-band lower 635 may cause secondary 40 MHz sub-band 634 to be unavailable. In this case, only primary 40 MHz sub-band 631 may be used. While secondary 20 Mhz upper 636 has a high score, traffic or other devices using secondary 20 MHz lower sub-band 635 may cause the IoT device to avoid communication in the full range to reduce interference by and for other devices that may be present on secondary 20 MHz lower sub-band 635.

In Example 3, secondary 20 Mhz sub-band upper 636 may have a low score and, similar to Example 2, only primary 40 Mhz sub-band 631 may be used. If both secondary 20 MHz sub-band lower 635 and secondary 20 Mhz sub-band 636 have low scores, as shown in Example 4, primary 40 MHz sub-band 631 may be used.

In some embodiments, primary 20 Mhz sub-band 632 may be required for backward compatibility with older IoT devices. This backward compatibility may require that primary 20 MHz sub-band 632 always be used, regardless of the quality of the signal thereon. For Examples 5-7, poor scores on secondary 20 MHz sub-band 633 may cause communication to occur only on or within primary 20 MHz sub-band 632. As the scores of other sub-bands within 80 MHz band 630 may be too low for reliable, high-quality communication. In Example 8, primary 20 MHz sub-band 632 may have a low score. But because it is required, communication may still be necessary within this band. In another embodiment, primary 40 MHz sub-band 631 may be used because the score given to secondary 20 MHz sub-band 633 is high. Since primary 20 Mhz sub-band is required (in the case where backwards compatibility is required), the use of a high-quality band does not negatively impact the system.

The examples shown in Table 1 are merely that, examples. In some embodiments, any and all sub-bands may be available. In these embodiments, a hierarchy may not be implemented. In other embodiments, sub-bands other than primary 20 MHz sub-band 632 may be required for compatibility with legacy devices or defined communication schemes. In these embodiments, a different hierarchy and decision tree may be used. In still other embodiments, further tessellation of the bands may occur, creating smaller or larger bands and sub-bands that may have higher, lower, or no hierarchy.

When a device is first powered up and is setting up communication with APs, STA scans the list of the APs and chooses whether to indicate an OMN. Various decision points may be used in determining the bandwidth for communication with the AP. In one embodiment, the user may force the STA to move to 20 MHz operation. In another embodiment, the STA may estimate path-loss by looking at RSSI. In this embodiment, the STA may evaluate only RSSI or it may evaluate RSSI in view of the AP transmit power from a beacon message. In still another embodiment, the STA may scan the contiguous 20 MHz channels within the 80 MHz channel and the two adjacent 80 MHz channels. By assessing the number of APs and the RSSI, the STA may determine how much interference is present on adjacent channels. The STA may scan all of the 20 MHz sub-bands of the 80 MHz channel and estimate the number of APs, the AP RSSIs and the AP primary channel locations. The remaining power level of the device may determine the bandwidth. For example, if the remaining level is below a threshold value, lower frequency bandwidths may be selected. In another embodiment, congestion on an 80 MHz channel may impair performance. Since WiFi is a shared medium, there may be significant congestion in the system, which may lower the achievable throughput by the STA from what is possible in ideal conditions. By monitoring traffic in the bandwidth, it may be possible to estimate the maximum possible throughput and determine if a move to another bandwidth is appropriate.

If the link with the AP is already established, it may be desired to shift to other bandwidths or sub-bandwidths during device operation. STA first establishes a link with the AP using 80 MHz mode. The STA then determines if a move to 20 MHz is appropriate. In one embodiment, the user may force the STA to move to 20 MHz operation. In another embodiment, the STA may estimate path-loss by looking at RSSI. In this embodiment, the STA may evaluate only RSSI or it may evaluate RSSI in view of the AP transmit power from a beacon message. In still another embodiment, the ACI may be estimated by reviewing the hardware ACI, a glitch counter, or other receive counters that may indicate the presence of interference from adjacent channels. In still another embodiment, the STA may check a secondary sub-channel frames received or dropped to estimate OBSS. The remaining power level of the device may determine the bandwidth. For example, if the remaining level is below a threshold value, lower frequency bandwidths may be selected. In another embodiment, congestion on an 80 MHz channel may impair performance. Since WiFi is a shared medium, there may be significant congestion in the system, which may lower the achievable throughput by the STA from what is possible in ideal conditions. By monitoring traffic in the bandwidth, it may be possible to estimate the maximum possible throughput and determine if a move to another bandwidth is appropriate.

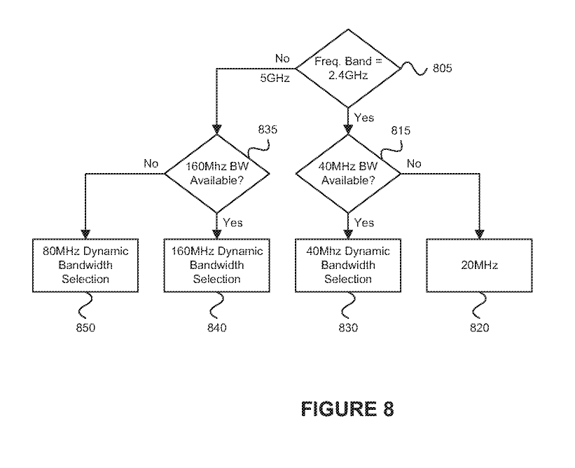

FIG. 8 illustrates a method 800 for entering a dynamic bandwidth selection scheme based on the available bandwidths. If the frequency band for communication is 2.4 GHz in decision step 805, it is next determined if there is a 40 MHz bandwidth available in decision step 815. If there is not a 40 MHz bandwidth available, communication is completed in a 20 MHz bandwidth in step 820 according to FIG. 6. If there is a 40 MHz bandwidth available, dynamic bandwidth selection is completed in step 830 for 40 MHz to determine if the full 40 MHz bandwidth is to be used or if a 20 MHz sub-bandwidth is to be used.

If the frequency band is not 2.4 GHz, but is 5 GHz in decision step 805, it is determined if 160 MHz is available in decision step 835. If 160 MHz is available, 160 MHz dynamic bandwidth selection is executed in step 840. 160 MHz dynamic bandwidth selection may use the entire 160 MHz bandwidth, or different sub-bandwidths of 80 MHz, 40 MHz, or 20 MHz according to FIGS. 6 and 7. If 160 MHz is not available in decision step 835, 80 MHz dynamic bandwidth selection is executed in step 850. 80 MHz dynamic bandwidth selection may use the entire 80 MHz bandwidth, or different sub-bandwidths of 40 MHz or 20 MHz according to FIGS. 6 and 7.

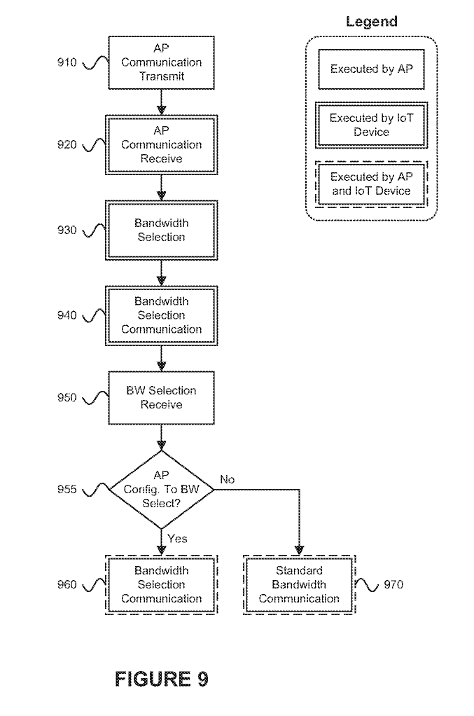

FIG. 9 illustrates a method 900 for determining the appropriate band or sub-band according to one embodiment of the present invention. First, an AP begins communication with the IoT device in 910 by transmitting a communication request. The communication request may include the desired or specified bandwidth for the AP as well as the available sub-bands. The communication request is then received by the IoT device in step 920. Using the available information from the AP and executing the method of the above specification, the IoT device may execute a bandwidth selection routine in step 930 to determine which of the available bands or sub-bands are desired based on the attenuation, interference, or available battery power (or other variables that may determine the optimal communication band or sub-band). The bandwidth selection may then be communicated to the AP in step 940 by an OMN frame, an RTS/CTS, or other management frames to notify operating bandwidth switch to the AP. The selected band or sub-band is received by the AP in step 950. If the AP can be or will be configured to communicate within the desired band (from the IoT device) in step 955, communication will proceed within the band or sub-band from step 940. However, if the AP cannot or will not configure itself to communication within the desired band from the IoT device, communication will continue at the band or sub-band defined by the standard. In one embodiment, the IoT device may terminate communication of substantive information if the desired bandwidth from step 940 is not accepted by the AP.

In the above description, numerous details are set forth. It will be apparent, however, to one of ordinary skill in the art having the benefit of this disclosure, that embodiments of the present invention may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “encrypting,” “decrypting,” “storing,” “providing,” “deriving,” “obtaining,” “receiving,” “authenticating,” “deleting,” “executing,” “requesting,” “communicating,” “initializing,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

Specific commands ore messages referenced in relation to the above-described protocol are intended to be illustrative only. One of ordinary skill in the art would understand that commands of different specific wording but similar function may be used and still fall within the ambit of the above description.

Embodiments described herein may also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer-readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions. The term “computer-readable storage medium” should be taken to include a single medium or multiple media (e.g., a centralized or distributed database and/or associated caches and servers) that store one or more sets of instructions. The term “computer-readable medium” shall also be taken to include any medium that is capable of storing, encoding or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present embodiments.

The algorithms and displays presented or referenced herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the embodiments as described herein.

The above description sets forth numerous specific details such as examples of specific systems, components, methods and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth above are merely exemplary. Particular implementations may vary from these exemplary details and still be contemplated to be within the scope of the present invention.

It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A wireless communication device comprising:
a radio frequency (RF) front end coupled to at least one antenna;
a wireless access point (AP) receiver module coupled to an output of the RF front end; and
a bandwidth decision module for receiving at least one characteristic of a signal from the wireless AP receiver module,
wherein the at least one characteristic is one of a received signal strength indicator (RSSI), adjacent channel interference (ACI), and overlapping basic service set (OBSS), and
wherein the bandwidth decision module selects a selected bandwidth for communication of wireless information from a first bandwidth and a second bandwidth, and provides a configuration to the RF front end based on the selection, and
wherein the second bandwidth is a subset of the first bandwidth.

2. The wireless communication device of claim 1, wherein the bandwidth decision module selects the bandwidth for communication of wireless information based, in part, on available power remaining in a battery coupled to the wireless communication device.

3. The wireless communication device of claim 1, wherein the at least one characteristic further comprises a statistic of the RSSI, ACI, or OBSS, the statistic derived from a plurality of scans of the RSSI, ACI, or OBSS.

4. The wireless communication device of claim 1, wherein the at least one characteristic is identified for each of the first bandwidth and the second bandwidth.

5. The wireless communication device of claim 1, wherein the second bandwidth is a required bandwidth.

6. The wireless communication device of claim 1, wherein the first bandwidth and the second bandwidth are first and second subsets of a third bandwidth.

7. The wireless communication device of claim 6, wherein the bandwidth decision module is to select a bandwidth from the first bandwidth, the second bandwidth, or the third bandwidth.

8. The wireless communication device of claim 1, wherein the bandwidth decision module selects a bandwidth at device start up.

9. The wireless communication device of claim 1, wherein the bandwidth decision module selects a second bandwidth during device operation, the second bandwidth different from a first bandwidth selected at device start up.

10. The wireless communication device of claim 1, wherein the communication provided to the RF front end from the bandwidth decision module is an operating mode notification (OMN) generated by an OMN frame creation module.

11. A method for selecting a communication bandwidth for wireless communication, the method comprising:
receiving a signal;
determining at least one characteristic of the signal, wherein the at least one characteristic is one of a received signal strength indicator (RSSI), an adjacent channel interference (ACI), and an overlapping basic service set (OBSS); and
selecting a selected bandwidth for wireless communication from a first bandwidth and a second bandwidth based on the at least one characteristic of the signal, wherein the second bandwidth is a subset of the first bandwidth.

12. The method for selecting a communication bandwidth for wireless communication of claim 11, wherein the at least one characteristic is determined at a first time and a second time and a statistic for the at least one characteristic is derived from the characteristic determined at the first time and the second time.

13. The method for selecting a communication bandwidth for wireless communication of claim 11, wherein the at least one characteristic is determined for a first bandwidth and a second bandwidth.

14. The method for selecting a communication bandwidth for wireless communication of claim 13, wherein the second bandwidth is a required bandwidth.

15. The method for selecting a communication bandwidth for wireless communication of claim 13, wherein the first bandwidth and the second bandwidth are subsets of a third bandwidth.

16. The method for selecting a communication bandwidth for wireless communication of claim 15, wherein the selecting a bandwidth for wireless communication selects from the first bandwidth, the second bandwidth, or the third bandwidth.

17. The method for selecting a communication bandwidth for wireless communication of claim 11, wherein the at least one characteristic is assigned a credit based on a comparison to the characteristic to at least one threshold for the characteristic, and wherein the bandwidth is selected based, in part, on the credit.

18. A dynamic bandwidth selection module comprising:
an input for receiving at least one characteristic of a wireless bandwidth for communication with an access point (AP), the at least one characteristic derived from one of a received signal strength indicator (RSSI), adjacent channel interference (ACI), and overlapping basic service set (OBSS); and
an output for selecting a wireless bandwidth from a plurality of bandwidths, the output coupled to an operating mode notification (the OMN) frame module for generation of a signal to a radio frequency (RF) front end for receiving wireless communication signals.

19. The dynamic bandwidth selection module of claim 18, wherein the plurality of bandwidths comprises a first bandwidth and a second bandwidth and a third bandwidth, and wherein the first bandwidth and the second bandwidth are subsets of the third bandwidth.

20. The dynamic bandwidth selection module of claim 18, wherein the at least one characteristic further comprises a credit assigned to at least one of the received RSSI, ACI, or OBSS.
